(19) United States
(12) Patent Application Publication
(10) Pub. No.: US 2025/0185049 A1
(43) Pub. Date: Jun. 5, 2025

(54) Network Resource Allocation based on User Excitement

(71) Applicant: Comcast Cable Communications, LLC, Philadelphia, PA (US)

(72) Inventor: Ivan Ong, Malvern, PA (US)

(21) Appl. No.: 18/527,540

(22) Filed: Dec. 4, 2023

(51) Int. Cl. H04W 72/51; H04W 72/0457; H04W 72/566

(52) U.S. Cl. CPC H04W 72/51; H04W 72/0457; H04W 72/566

(57) ABSTRACT

Systems, apparatuses, and methods are described for a device configured to optimize network configurations based on a determined intensity of a user's operation of a device or interaction with an application function. A system may be configured to monitor and analyze the use of the device to determine varying levels of intensity the user imparts to the device associated with a particular function of an application. System resources can be adjusted to provide more or less network resources to implement the function based on the determined intensity.

### BACKGROUND

Software applications, such as video streaming applications, online gaming applications, Internet browsers, and the like, may require network resources for satisfactory operation. However, network resources may need to be adjusted to accommodate a user's interactions with application functions based on the excitement or intensity level of the user's interactions. These and other shortcomings are identified and addressed by the disclosure.

### SUMMARY

The following summary presents a simplified summary of certain features. The summary is not an extensive overview and is not intended to identify key or critical elements.

Systems, apparatuses, and methods are described for receiving inputs from a user who is using a software application, and using those inputs to determine an excitement level for the user and to adjust network parameters such as bandwidth allocation, data priority, etc. based on that excitement level. The inputs may include various types of excitement level feedback from the user, such as an amount of touch pressure being exerted by the user's hands, a rapidity of user inputs to a controller, degree of tilting a handheld device, perspiration, heart rate, etc. If a user is aggressively gripping a controller and rapidly entering user inputs to an application of a computing device, then that application and/or computing device may be granted a higher amount of bandwidth and data priority. If a user is calmly holding a controller and entering inputs slowly, then the application and/or computing device may be granted a smaller amount of bandwidth and lower data priority. Other factors may be used as well, and the network resource allocation described herein may allow for a more enjoyable user experience.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A through 3D illustrate several examples of how network resources may be allocated differently based on user excitement level inputs.

FIGS. 4A through 4C are example tables for storing rules associated with determining excitement values, excitement levels, and an allocation of network properties.

FIGS. 5A and 5B are flow charts detailing how a device may determine an excitement level based on user inputs, and how a device may allocate and configure resources based on the excitement level.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

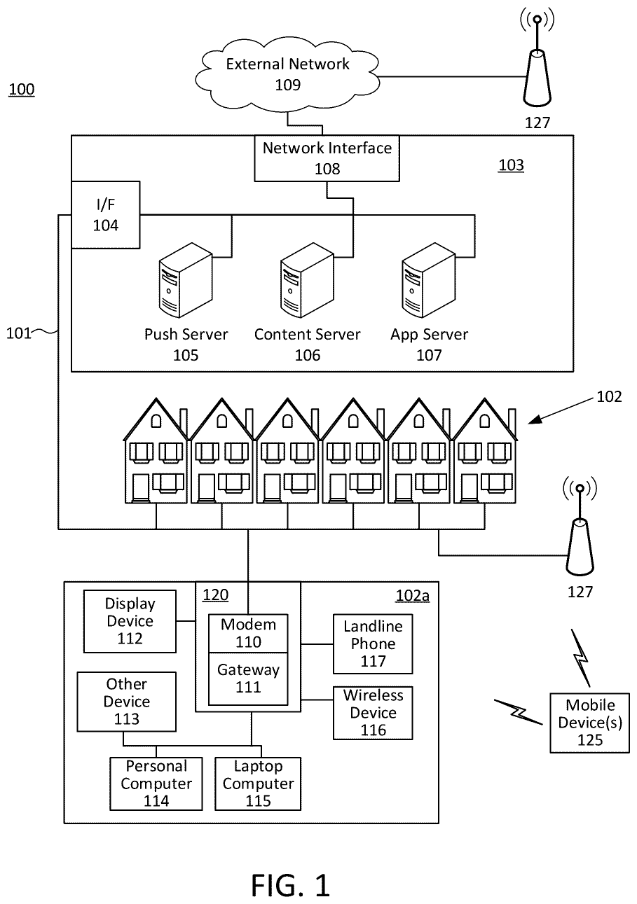

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Although shown separately, the push server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

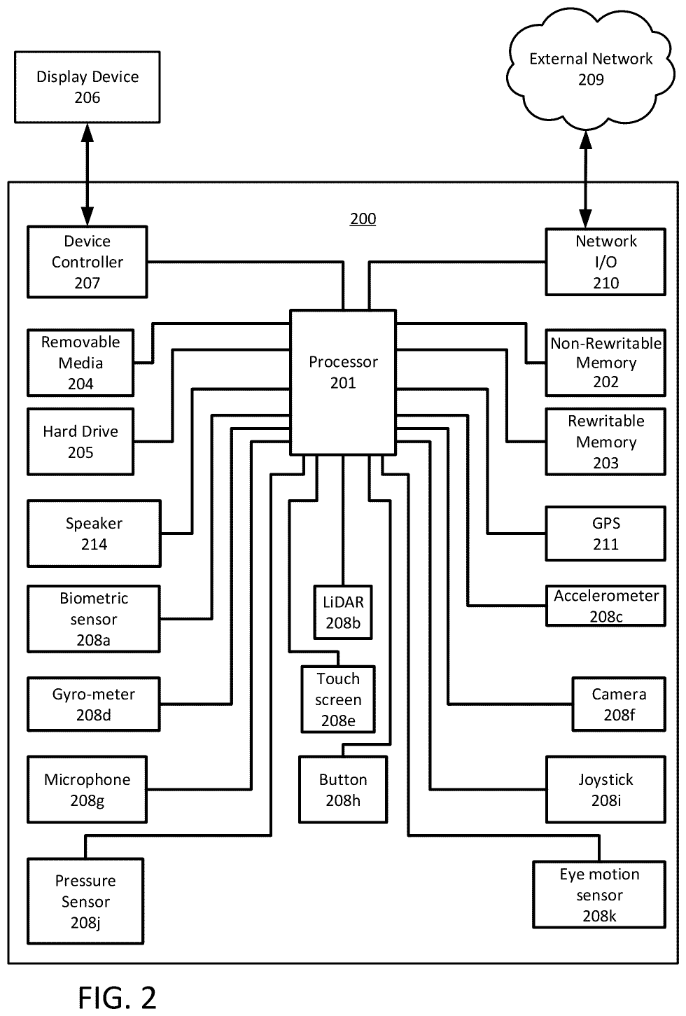

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a game controller (wired and/or wireless), a mobile phone, a tablet, a laptop, a virtual reality (VR) headset, a gateway, a device that may serve as a gateway, a wearable device, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), a microphone, a camera, biometric data (e.g., a blood oxygen sensor, a heart rate monitor, a perspiration sensor, a breath monitor, an eye tracking sensor, etc.), a handset, a game controller, a VR headset, a gyro meter, an accelerometer, a pressure sensor, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

A device 200 may comprise one or more input devices 208. Input devices 208 may comprise, but are not limited to, a biometric sensor (e.g. a heart rate monitor, a blood oxygen sensor, a electrodermal activity sensor, a breathing monitor, etc.) 208a, a light detection and ranging (LiDAR) 208b sensor, an accelerometer 208c, a gyro-meter (e.g., a gyroscope) 208d, a touch screen 208e, a camera 208f, a microphone 208g, a plurality of buttons 208h, a plurality of joysticks 208i, a plurality of pressure sensors 208j (e.g., pressure sensors to detect the force applied to a touch on a touch screen and/or the force applied to a button or a joystick), an eye motion detector 208k, and/or any other desired type of input device.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

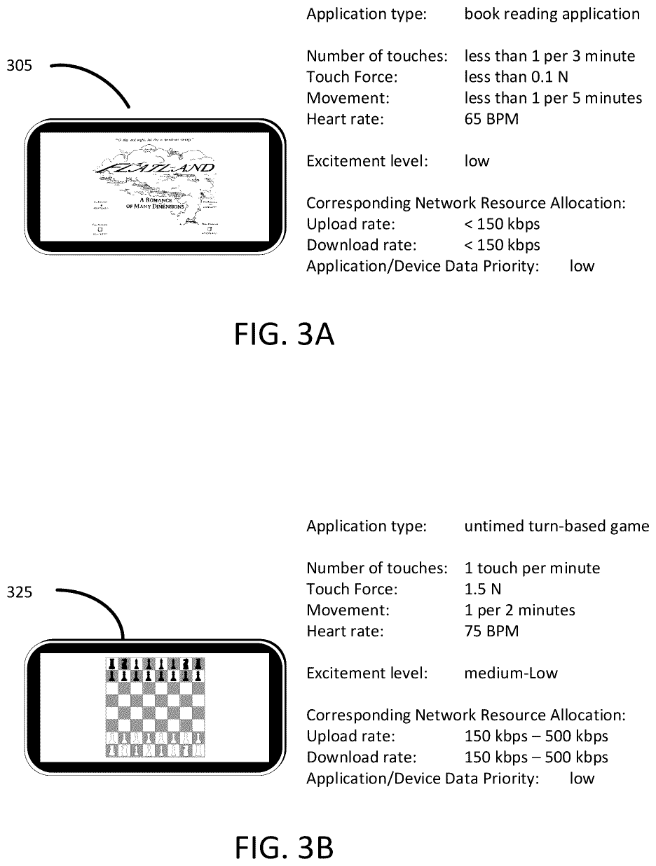

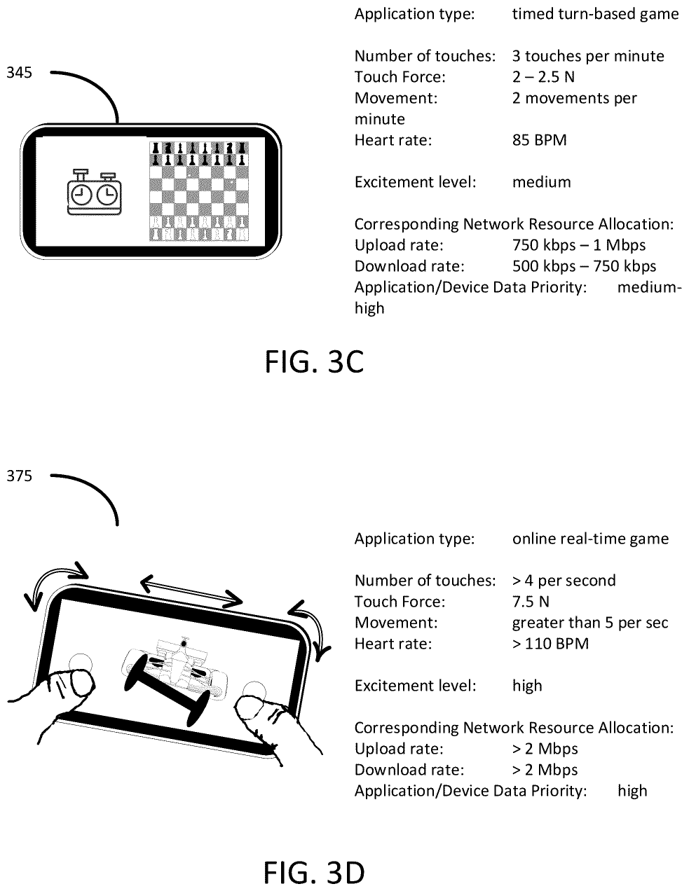

A user who is engaged in a high-stress situation may be less tolerant of network disruptions or delays. Also, a software application's need for network resources may be proportional to the degree of user inputs that are received while using the application. An application that requires constant user input may be less tolerant of network delays than an application that only requires occasional user input. As described herein, user excitement level may be determined based on types of input, and network resources may be allocated accordingly. FIGS. 3A through 3D illustrate several examples of how network resources may be allocated differently based on user excitement level inputs. FIG. 3A shows an example of a device 200 with a touchscreen (e.g., a touch displaying a digital book, a PDF file, and/or another type of image and/or text file. A user may be passively reading a digital book via a book reader application 305, and might be holding the device 200 relatively still while doing so. The user may provide inputs only once every few minutes, to turn a page, make a highlight, etc. The device 200 may detect the motion (or lack thereof) and the rate of user input, and may compare these detected inputs with various excitement thresholds to determine a corresponding excitement level. That excitement level may be used to determine network resource allocation for the device 200 and/or the book-reader application 305. For example, as the user appears to be relatively calm, the user may be determined to have a relatively low excitement level, and as a result, network resource allocation may be less critical. A low excitement level may result in configuring network resources so that the data for the device 200 and/or book-reader application 305 may be allocated a smaller amount of bandwidth and/or assigned a lower priority. The network resource allocation may also be based on the type of application, since different applications may require different network qualities. For example, the book-reader application 305 may not require much bandwidth, as digital books are relatively small and the act of reading them does not require much additional bandwidth beyond simply delivering the book itself (e.g., perhaps a small amount of additional data for dynamic advertisements, book highlighting, note-taking, etc.). These application requirements may also be reflected in the threshold data, such that a given excitement level may correspond to different network qualities for different types of applications.

FIGS. 3B and 3C show an example of a turn-based application (e.g., a game of chess). In such a turn-based application 325, a user may provide user input at a higher rate than in the book-reader application 305, as the user may be playing an online game against an opponent. The higher rate of input may be detected by a device 200, and using the threshold data above, the device 200 may determine that the user's excitement level is a bit higher than in the book reader application 305. This slightly higher excitement level may correspond to a different network resource allocation. The turn based application (e.g., a game of chess) 325 may be allocated a 150-500 kbps amount of bandwidth, and the data of the application may be given a slightly higher priority. As noted above, an excitement level may correspond to different network qualities depending on the type of application. In the turn based application (e.g., a game of chess) 325, for example, a particular level of excitement may correspond with a first network condition if the game is untimed (e.g., players are given an unlimited amount of time in which they can make their moves), and a second network condition if the game is timed (e.g., a chess clock limits the amount of time each player has to make their moves).

FIG. 3C shows an example of a user playing a timed turn-based application. A user playing a timed turn-based application (e.g., a game of chess with a limited amount of time per move) 325 may provide more user input at a greater rate than that of an untimed 345 turn-based application (e.g., an untimed game of chess) 325. As the time limit shortens and/or nears the end, a user may feel more rushed and/or frantic, and the user may, in turn, provide more inputs while interacting with a device 200. The device 200 may detect an increase in movement of the device 200 by an accelerometer 208c, the device 200 may detect an increase in a heart rate and/or a perspiration of the user by a biometric sensor 208a (e.g., a heart rate monitor and/or an electrodermal activity (EDA) sensor) input, and/or the device 200 may detect an increase in a number of taps on a touch screen 208e, and/or an increase in touch force by a pressure sensor 208j, for example, if the user is rushed and/or frantic. A device 200 may detect an increase in the number of device inputs and/or intensities and, in turn, determine a higher excitement level. A moderate excitement level, as may be experienced by a user playing a timed turn-based application 325, may result in configuring network resources so that the data for the device 200 and/or the timed turn-based application may be allocated an increased 250 to 500 kbps of bandwidth, and/or an increased priority value. In a timed turn-based application, a user may decide to wait until the time limit is nearly over before inputting a move, and a device 200 with greater bandwidth available and/or a higher priority may be less likely to experience latency issues that may cause a user to breach the time limit and be penalized (or even lose the game). The data of a user sending and/or receiving a limited amount of data may be placed in a lower priority state and/or assigned fewer network resources and may be more likely to experience latency issues, for example, if the inputs of a user to a device 200 are not also considered.

FIG. 3D shows an example of a user playing an online real time video game (e.g., a racing game where a user may compete against online opponents). A user playing a real time video game (e.g., a racing video game) 375 may provide even more indicators of excitement to a device 200. For example, the indicators of excitement of a user of a device 200 may be detected by multiple types of device inputs (e.g., motion of the device as may be detected by accelerometers 208c and/or gyro-meters 208d, multiple presses of buttons 208h, and/or use of a joystick 208i) at different rates and/or intensities (e.g., more taps in a given period of time, continuous input, and/or greater force of a touch on a touch screen). A user playing a real time video game may signal their elevated excitement level with certain biometric indicators that may be detected by a biometric sensor 208a (e.g., an increase in perspiration detected by an EDA sensor, an elevated heart rate detected by a heart rate monitor, an increase in eye motion as detected by an eye tracking sensor, attention of the user as detected by a camera, etc.). A device 200 may detect the increased amount and/or intensities of inputs and may compare these inputs with various input specific excitement value tables to determine a resulting excitement level. A high excitement level may result in configuring network resources so that the data for the device 200 and/or online real time video game 375 may be allocated a high amount of bandwidth and/or assigned a high priority.

There may be instances during an online session, furthermore, where the excitement level of a user may shift from a higher excitement level to a lower or from a lower excitement level to a higher. A device 200 may determine a lower excitement level, for example, if a user is between competitive sessions of an online game. A device 200 may determine an increase in an excitement level of user, for example, if the user enters a portion of the game that requires less user action. A user of an online racing game, for example, may move from a portion of a race where the driver is passing opponents and/or navigating a twisted portion of a track to a portion of the race consisting of a long straight stretch of track with no other competitors in the area. The user may not need to move the device as much in an online racing game, for example, if the user does not need to steer a vehicle around obstacles in the game. The heart rate of the user may decrease, for example, if the user is in a less stressful area of the game. A device may detect fewer device inputs, lower input intensities, and/or a lowered heart rate and, in turn, determine that the user has a lower excitement level. The lower excitement level may result in configuring a network so that the data for the device 200 and/or real time video game 375 may be allocated a reduced amount of bandwidth and/or assigned a lower priority

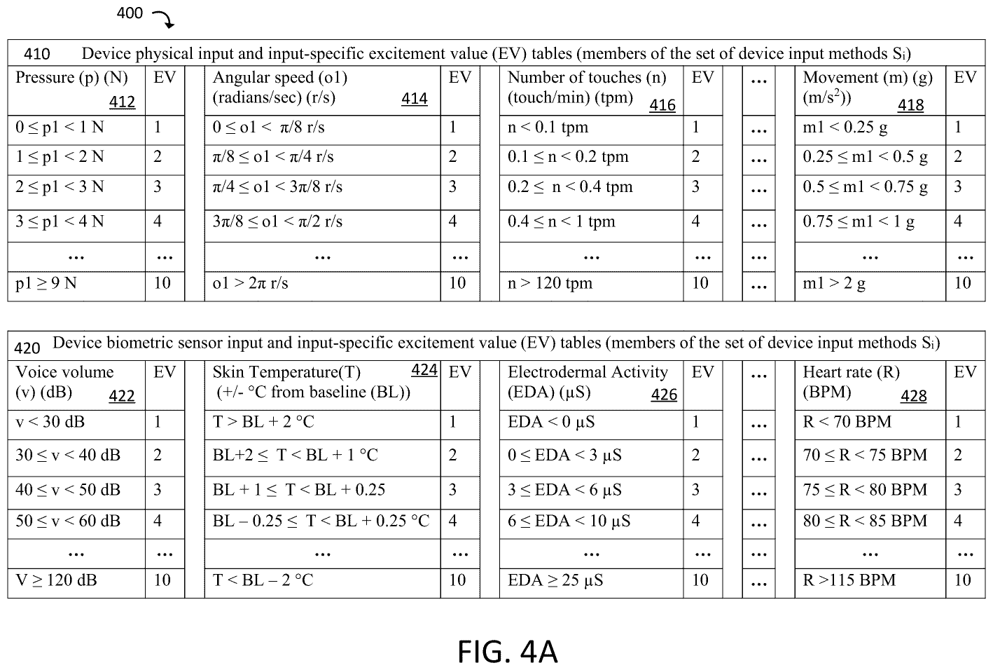

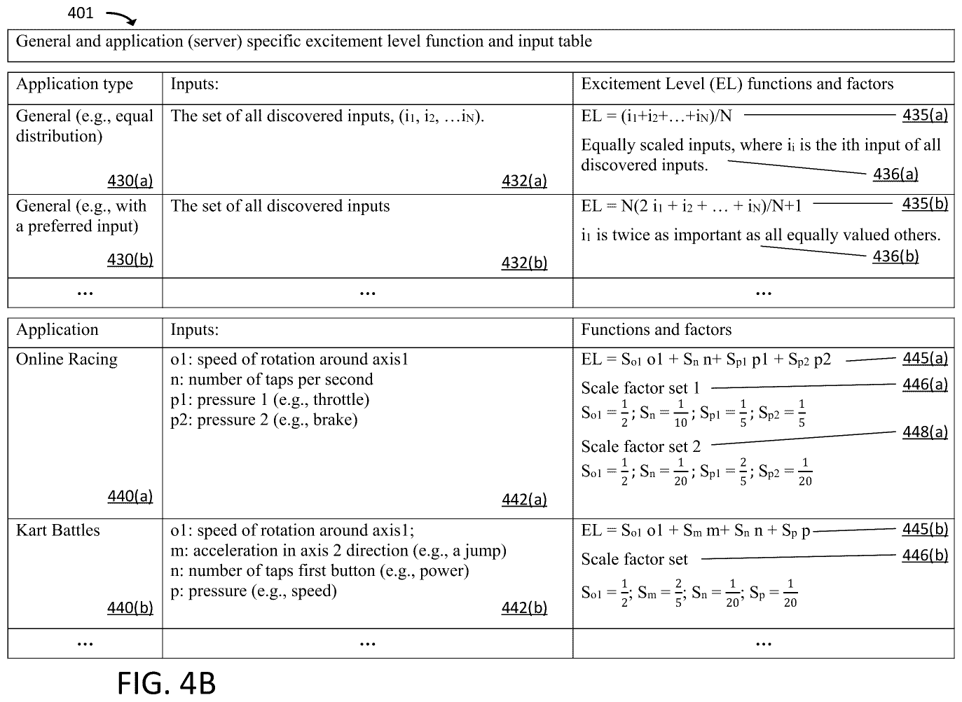

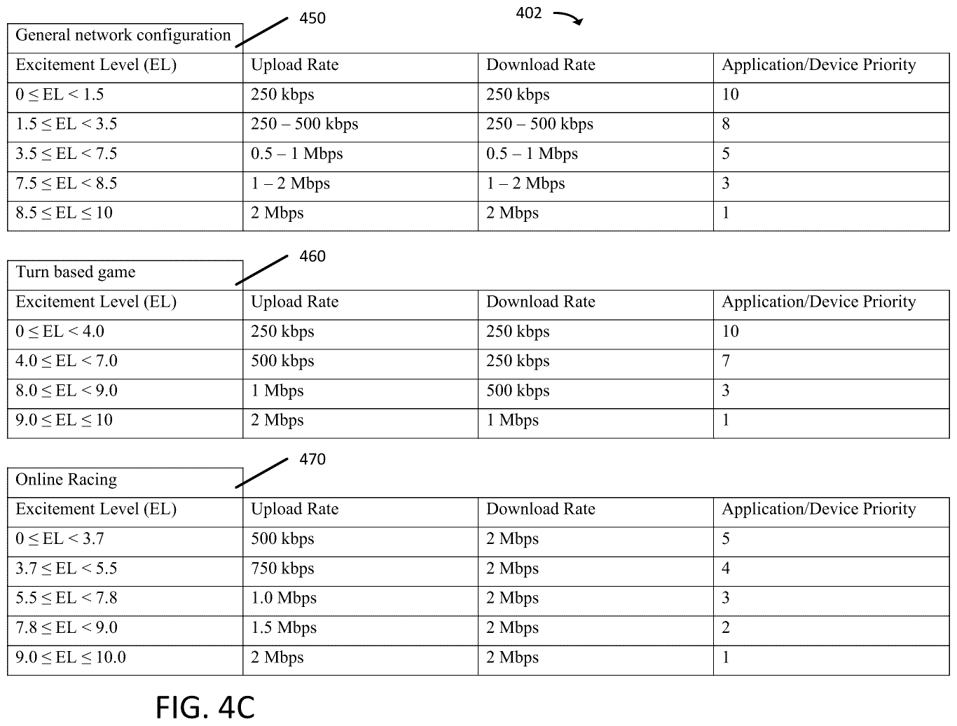

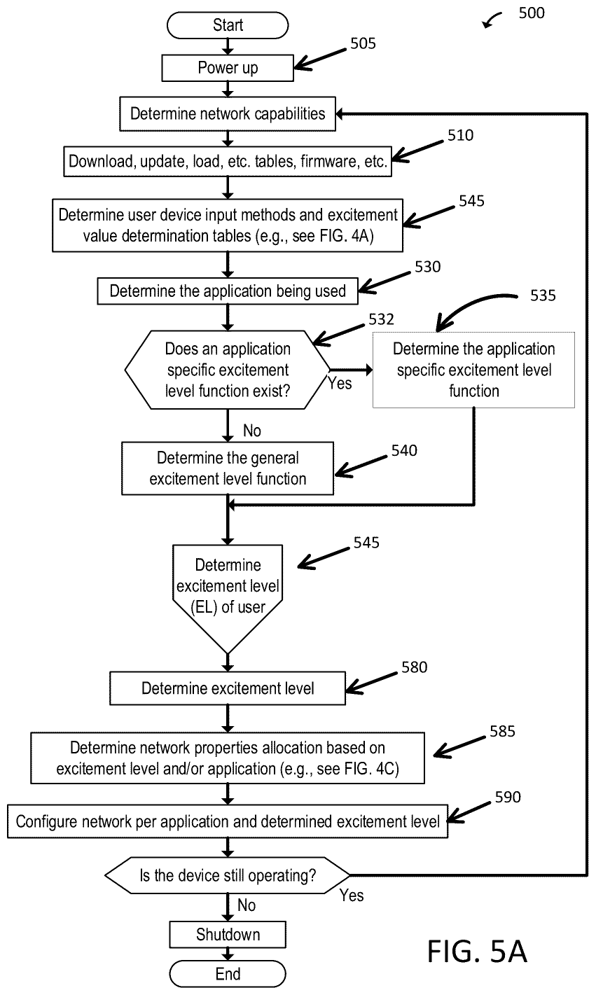

FIGS. 4A through 4C are example tables for storing rules associated with determining excitement values, excitement levels, and an allocation of network properties. A table may include details for determining an excitement level based on the type of a device input and/or a device input value of the device input. A table may include details for determining the excitement level based on scaling the device input values. A table may include details for allocating network resources (e.g., upstream bandwidth, downstream bandwidth, priority levels, etc.) based on the excitement level. A table may be updated (created, revised, modified, etc.) based on an administrator configuration. A table may be updated (created, revised, modified, etc.) based on a server configuration.

FIG. 4A shows an example physical input and input-specific excitement value table 410 and an example biometric sensor input and excitement value table 420. The physical input and input-specific excitement value table 410 and/or biometric sensor input and input-specific excitement value table 420 may provide a set of device inputs that may be used for an excitement level determination. The physical input and input-specific excitement value table 410 may comprise a pressure input-specific excitement value table 412 based on a pressure sensor 208j, an angular speed input-specific excitement value table 414 based on motion detected by a gyro-meter 208d, a number of touches input-specific excitement table 416 based on touches on a touch screen 208e, and/or an acceleration input-specific excitement table 418 based on motion detected by an accelerometer 208c. The biometric sensor input and input-specific excitement value table 420 may comprise a voice volume input-specific excitement value table 422 based on sound received by a microphone 208g, a skin temperature input-specific excitement value table 424 based on a measurement by a biometric sensor 208a (e.g., a thermometer), an EDA input-specific excitement value table 426 based on a measurement by a biometric sensor 208a (e.g., an EDA sensor), an heart rate input-specific excitement value table 428 based on a measurement by a biometric sensor 208a (e.g., a heart rate monitor), an excitement value based on more rapid eye motion detected by an eye tracking sensor, and/or an excitement value based on user attention detected by a camera. An input-specific excitement value table 412-428 may determine an input-specific excitement value (EV) based on a device input.

A device 200 may use a pressure input-specific excitement value table 412 to determine an input-specific excitement value based on a pressure sensor 208j. A device 200 may have a plurality of pressure sensors 208j. The pressure sensor(s) 208j may be configured to determine the pressure applied to other device inputs (e.g., device input buttons 208h, device input joysticks 208i, a touch screen 208e, etc.). A pressure sensor 208j may be able to detect a range of applied pressures (e.g., a pressure sensor 208j may be configured to determine a range of pressures between 0 and 10 Newtons (N)), and the pressure input-specific excitement value table 412 may determine an excitement value based on the pressure range. A user of an application may push harder on a button 208h, a touch screen 208e, and/or a joystick 208i, for example, as the user of the application becomes more engaged with the application and/or more excited. A device 200 may receive a series of pressure values while the user is interacting with an application. The series of pressure values may increase from less than 1 N when the user begins interacting with the application to more than 9 N as the excitement (intensity) of the user interacting with the application increases. The device 200 may determine an increase the pressure input-specific excitement value from a value of 1 to a value of 10, for example, based on the detected increase in applied pressure to the pressure sensor 208j of less than 1 N to over 9 N. A device 200 may determine an excitement value based on a pressure value per unit time. The device 200 may determine an increase in an excitement value, for example, based on a constant pressure, and/or contact, of a user with the device 200.

The device 200 may use an angular speed input-specific excitement value table 414 to determine an input-specific excitement value based on a change in an angular orientation detected by a gyro-meter 208d in a period of time. A device 200 may have a plurality of gyro-meters 208d to determine the orientation. A user may change the orientation of a device 200 more often and/or or more quickly based on an increase in user excitement associated with use of an application. An angular speed input-specific excitement value table 414 may determine an increase in an excitement level based on the speed of the rotation about a first axis as detected by a gyro-meter 208d. The user may rotate a device 200 more quickly, for example, if the user is playing an online racing game (e.g., as described herein in FIG. 3D) and the rotation of the device 200 corresponds to steering a vehicle in the online racing game. The device 200 may determine that the angular speed input-specific excitement value may be increasing, for example, if the rate of rotation increases from less than π/8 radians per second (r/s) to greater than π r/s. The device 200 may determine the input-specific excitement level may be decreasing, for example, if the rate of rotation decreases from greater than π r/s to less than π/8 r/s.

The device 200 may use a number of touches input-specific excitement value table 416 to determine an input-specific excitement value based on a number of touches of a touch screen 208e per unit time (e.g., touches per minute (TPM)). A user of the device 200 may begin to tap a touch screen 208e more often as the user begins to interact more with an application. The increased number of taps on the touch screen may be an indication of increased excitement of the user. The device 200 may receive the number of touches over a period of time. The device 200 may determine that the input-specific excitement value based on the number of touches per unit time may be increasing from less than 2 to 10, for example, if the number of touches on a touch screen 208e increases from less than 1 touch every 5 minutes to more than 2 touches per second. The device 200 may determine the input-specific excitement value based on the number of touches may be decreasing, for example, if the device 200 determines the number of touches per unit time is decreasing.

The device 200 may use an acceleration input-specific excitement value table 418 to determine an input-specific excitement value based on an accelerometer 208c. A user may begin to move and/or shake a device 200 more as the excitement of the user increases. An accelerometer may be able to detect a range of acceleration values in a particular direction. A directionless range of an accelerometer may range from 0 meters per second squared (m/s²) to over 19.6 m/s² (e.g., 0 units of gravitational acceleration at the surface of the earth (g) to over 2 g). A device 200 may receive an acceleration value from an accelerometer 208c. The device 200 may determine an input-specific excitement value based on the acceleration value and the acceleration input-specific excitement value table 418. The device 200 may determine an increase in an acceleration input-specific excitement value (e.g., from 1 to 10) in a first direction, for example, if the device 200 receives acceleration values that indicate greater movement (e.g., the acceleration increases from 0.1 g to more than 2 g) in the first direction. The device 200 may determine a decrease in the acceleration input-specific excitement value, for example, if the device 200 receives acceleration values that indicate less movement. A device 200 may use an accelerometer 208c to determine other input-specific excitement values, for example, based on analyzing a number of starts and/or stops, a total distance travelled, an average speed, a change in the acceleration, and/or the number of changes in acceleration in a period of time.

The device 200 may use a voice volume input-specific excitement value table 422 to determine an input-specific excitement value based on a decibel level of a user's voice detected by a microphone 208g. A user may begin to speak and/or vocalize louder as the excitement level of the user increases based on use of an application. A device 200 may receive a decibel level from a user device. The device 200 may determine an input-specific excitement value based on the decibel (dB) level. The device 200 may determine an increase in the voice volume input-specific excitement value (e.g., from 1 to 10), for example, if the decibel level of the user increases (e.g., from that of a whisper, 30 dB, to that of very loud yell, 120 dB). The device 200 may determine a decrease in the voice volume input-specific excitement value, for example, if the decibel level of the user decreases. The device 200 may receive device input from a second user device. The second user device may be a wearable device. The wearable device may have a microphone. The second device may be headphones with a blue tooth connection.

A device 200 may use a skin temperature input-specific excitement value table 424 to determine an input-specific excitement value based on a skin temperature detected by a biometric sensor 208a (e.g., a thermometer) input. As an individual becomes more excited, the skin temperature of the individual may decrease. A skin temperature of a user may decrease as the excitement level of the user increases based on use of an application. A skin temperature may be in degrees Celsius (° C.). The device 200 may receive the skin temperature value of the user. The device 200 may determine a skin temperature input-specific excitement value based on the received skin temperature value. The device 200 may determine an increase in the skin temperature input-specific excitement value, for example, if the skin temperature of the user decreases (e.g., from a skin temperature associated with a relaxed state to a skin temperature associated with an excited state that is 4° C. cooler). The device 200 may determine a decrease in the skin temperature input-specific excitement value, for example, if the skin temperature of the user increases.

A device 200 may use an electrodermal activity (EDA) input-specific excitement value table 426 to determine an input-specific excitement value based on a biometric sensor 208a (e.g., an EDA sensor) input. An EDA sensor may have a range of EDA values between 0 and 30 micro-Siemens (uS). The EDA sensor may determine a skin conductivity of a user. The skin conductivity of a user may depend on sweat gland activity of a user. The sweat gland activity of a user may change as the excitement level of the user changes. The EDA may increase, for example, if a user is sweating more based on an increase in the excitement level of a user. The device 200 may receive an EDA value. The device 200 may determine an EDA input-specific excitement value based on the EDA value. The device 200 may determine an increase in the EDA input-specific excitement value, for example, if the EDA value of the user increases. The device 200 may determine a decrease in the EDA input-specific excitement value, for example, if the EDA value of the user decreases. The device 200 may receive the EDA measurement from a second user device.

A device 200 may use a heart rate input-specific excitement value table 428 to determine an input-specific excitement value based on a biometric sensor 208a (e.g., a heart rate monitor) input. The heart rate of a user may increase from a baseline with increasing excitement level. The heart rate of a user may decrease from the baseline with a decreasing excitement level. A device 200 may receive a heart rate. The device 200 may determine a heart rate input-specific excitement value based on the heart rate received. The device 200 may determine an increase in the heart rate input-specific excitement value of the user, for example, if the heart rate of the user increases. The device 200 may determine that the heart rate input-specific excitement value of the user may increase from 1 to 10, for example, if the heart rate increases from less than 70 beats per minute (BPM) to more than 115 BPM. The device 200 may determine the heart rate input-specific excitement value decreases, for example, if the heart rate decreases.

While the discussion above refers to the device 200 performing various features, these features may be performed by any desired device, and not necessarily the same device that a user is using for the application. For example, a user may be playing a game on their smartphone, and the smartphone may provide information about the user's inputs to a gateway 111. The gateway 111 may use that information to make the various determinations discussed above, and to configure network parameters based on the user's excitement level. The various features may be performed separately by multiple devices. A device may receive user input data from one or more additional user devices. The one or more additional user devices may comprise a connected device. The one or more additional user devices may comprise a connected game controller. The one or more additional user devices may comprise a wearable device. The one or more additional user devices may comprise a VR headset. The one or more additional user devices may be connected to the first user device and/or the device via a radio connection.

A device input table may be updated (created, revised, modified, etc.) based on a device input type, a device input value, and/or a device input-specific excitement value. A device input table may be updated by a server and/or an administrator of the device.

FIG. 4B shows an example table for determining an excitement level based on a set of input-specific excitement values. An excitement level function table 401 may include a set of excitement level functions that may comprise an excitement level equation with a set of device input-specific excitement values as variables and a set of device input scaling factors as coefficients. The excitement level function may comprise one or more of available device inputs of a device 200. A device input scaling factor may be used to increase or decrease the weight (importance, significance, etc.) of an available input-specific excitement value with respect to the other available input-specific excitement values in the excitement level equation.

An excitement level function table may comprise, but is not limited to, one or more general excitement level functions 435 (a) and (b) and/or one or more application specific excitement level functions 445(a) and (b). An application specific excitement level function may be based on a specific application 440(a) and 440(b). A general excitement level function may comprise one or more of the input-specific excitement values 432(a) and (b) and/or a set of device input scaling factors 436(a) and 436(b). The general excitement level function may be determined, for example, from the sum of the excitement level values scaled by a corresponding set of device input scaling factors. A general excitement level function may evenly scale the one or more of the available device input excitement values 436(a). The general excitement level function may scale one or more variables with a greater weight 436(b).

A device 200 may have different scaling factors for different input-specific excitement values based on device inputs that may be more or less indicative of user excitement. A scaling factor for an input-specific excitement value based on angular rotation may be increased, for example, if rotation of the device 200 is considered more indicative of excitement. A scaling factor for an input-specific excitement value based on movement may be decreased, for example, if movement of the device 200 is considered less indicative of excitement. A scaling factor for an input-specific excitement value based on voice volume may be lowered, for example, if voice volume is less indicative of excitement.

A general excitement level function of the one or more general excitement level functions may scale different inputs of the one or more available device inputs differently based on the different inputs representing more or less indicative determinations of excitement level 436(b). A user may be more or less likely to use certain applications in certain geographic locations. The device 200 may use a general excitement level function with a preferred input for example, if the device 200 is determined to be in a certain location. The device 200 may use a general excitement level function with greater weight on angular rotation, for example, if the user is more likely to use an application that relies on angular rotation near an access point. The device 200 may use a general excitement level function with a lower weight on skin temperature, for example, if the device 200 is located outdoors. The user may be more or less likely to use a certain application at a certain time of day and/or day of the week. The device 200 may use a general excitement level function with a greater weight on a number of touches between 6 μm and 10 μm, for example, if the user is more likely to use an application that relies on a number of touches at night. The device 200 may use a general excitement level function with a greater weight on heart rate between 6 am and 10 am, for example, if the user is more likely to use an application that relies on heart rate in the morning.

An application specific level function 445(a) and (b) may comprise a subset of one or more device inputs (e.g., application specific device inputs) 442(a) and (b) and/or a set of application specific device inputs scaling factors 446(a), 446(b), and 448(a). An application specific excitement level may be determined, for example, from the sum of the application specific device inputs scaled by the application specific device input scaling factors (e.g., the excitement level functions 445(a) and 445(b)). The application specific device inputs 442(a) and (b) may be determined to be indicative of use of the application and/or indicative of use of different modes and/or features of the application that may have different bandwidth needs (e.g., an untimed turned based game or a timed turned based game as described herein in FIGS. 3B and 3C respectively). A device 200 may rely on an angular speed input-specific excitement value, but not on an acceleration input-specific excitement value, to determine an excitement level, for example, if the user is playing an online racing game (e.g., as described herein in FIG. 3D) that uses the rotation of the device 200 to steer the vehicle, but does not rely on movement of the device 200 for the application. A device 200 may rely on a number of touches input-specific excitement value, but not a rotation speed input-specific excitement value, for example, if the user is playing a chess game where movement of the pieces is based on touching a touch screen 208e, but rotation of the device 200 is not used in the application.

The application specific device input scaling factors may be determined to be indicators of user engagement in the application (e.g., rotating the device in an online racing game as described herein in FIG. 3D). A scale factor set 446(a) of a device 200 may have a scale factor for a rotation speed be greater than any other scale factor, for example, if the application is an online racing game and steering the vehicle requires a device 200 to be rotated, and steering the vehicle is a strongest indicator of user engagement with the application. A scale factor set 446(a) of a device 200 may have a scale factor for a number of taps be less than any other scale factor in the online racing game, for example, if tapping the touch screen 208e is used less frequently than other device inputs (e.g., pressure, angular speed, etc.).

An application specific excitement level function may have multiple sets of device input scale factors 446(a) and 448(a). An application may have multiple sets of device input scale factors 446(a) and 448(a), for example, a function may vary based on a time portion of the application, if an application has times in which a user may be more passive rather than being more engaged (excited) regarding the application. In an online racing game, for example, a user may not have to interact with a device, if the user is waiting for another race to begin. The device 200 may determine a decreasing excitement level based on the decreasing interaction of the user. The device 200 may determine a decreasing excitement level, for example, based on less eye motion detected by an eye tracking sensor. The device may determine a decreasing excitement level, for example, based on less user attention detected by a camera. The device 200 may determine a decreasing excitement level, for example, based on a decrease in angular rotation and/or motion. The device 200 may be configured to use a second set of scale factors 448(a) based on an excitement level falling below a threshold value. The second set of scale factors 448(a) may have one or more scale factors in the second set of scale factors that be more heavily weighted in the second set of scale factors than in the first. In an online racing game, a scale factor in the second set of scale factors 448(a) associated with the vehicle throttle may be more heavily weighted, for example, if the user excitement levels are below a threshold value. A vehicle throttle may be more heavily weighted, for example, if the vehicle starts an online race from a stop, a more heavily weighted throttle would allow the device to more quickly determine a rising excitement value at the beginning of an online race. As the excitement level increases, and exceeds a threshold value, the device 200 may be configured to use the first set of scale factors 446(a). As the vehicle reaches a peak speed the use of the throttle may become less, and the input-specific excitement value associated with the throttle decreases, the scale factor set may be changed to a set more indicative of excitement level.

An excitement level table may be updated (created, revised, modified, etc.) by receiving updates from a server and/or an administrator. An update may comprise, but is not limited to, one or more of a change in an excitement level function, a change in input device excitement values used, and/or a change in input device scaling factors.

FIG. 4C shows an example table for determining network configuration based on excitement level. A network parameter configuration table 402 may comprise preferred upload rates, preferred download rates, and/or application/device priority values based on excitement level and/or application. A device 200 may increase bandwidth and/or increase an application priority level based on an increase in excitement level. A device 200 may decrease bandwidth and/or a decrease an application priority level based on a decreased excitement level. A device 200 may allocate a band, bandwidth, and/or a priority level based on excitement level. A network configuration table may be specific for an application (e.g., turn based games, online racing games, stock trading applications, etc.). Certain applications may always need access to high bandwidth even when an excitement level is low. A user of an online racing game may generally need a higher bandwidth, for example, because a user interaction with an application is always changing (e.g., a vehicle may move quickly from portions of a track that require little user interaction to portions of a track that requires a great deal of user interaction). A network configuration table may be updated by a server and/or a device administrator.

A general network configuration 450 may be used based on a device 200 determining a network configuration table for a specific application is not available. The general configuration table 450 may evenly space network resources based on excitement level. For a particular type of application 460 and/or a specific application 470, a network configuration table may favor an allocation of higher frequency bands and/or greater bandwidth. In an online racing game, a user may momentarily be in a lower excited state, but may need to quickly access increased bandwidth. A user may need quick access to increased bandwidth, for example, if the user is transitioning from a long straight portion of track requiring little interaction of the user with the user device, to a portion of track with a number of sharp turns and a large number of other vehicles to maneuver around. For another type of application (e.g., a turned based application 460), a network configuration table may favor an allocation of lower frequency bands and/or lower bandwidth. In a turned based game, a user playing a game may benefit from some increased bandwidth, but may, very rarely, need the highest bandwidth available, and a network configuration table may account for this. The device 200 may increase bandwidth, for example, if the device 200 determined, based on excitement level, that more bandwidth is needed. The device 200 may reconfigure a connection from a low frequency band to a high frequency band, for example, if the device determined, based on excitement level, that a higher frequency band is needed.

A physical input and input-specific excitement value determination table 410, a biometric sensor input and input-specific excitement value determination table 420, an excitement level function table 401, and/or a network parameter configuration table 402 may be updated based on an updated table being made available. An update may be made available, for example, if a new application specific excitement level function is made available. An update may be made available, for example, to reflect new input methods being made available (e.g., a new biometric sensor and/or a new device input).

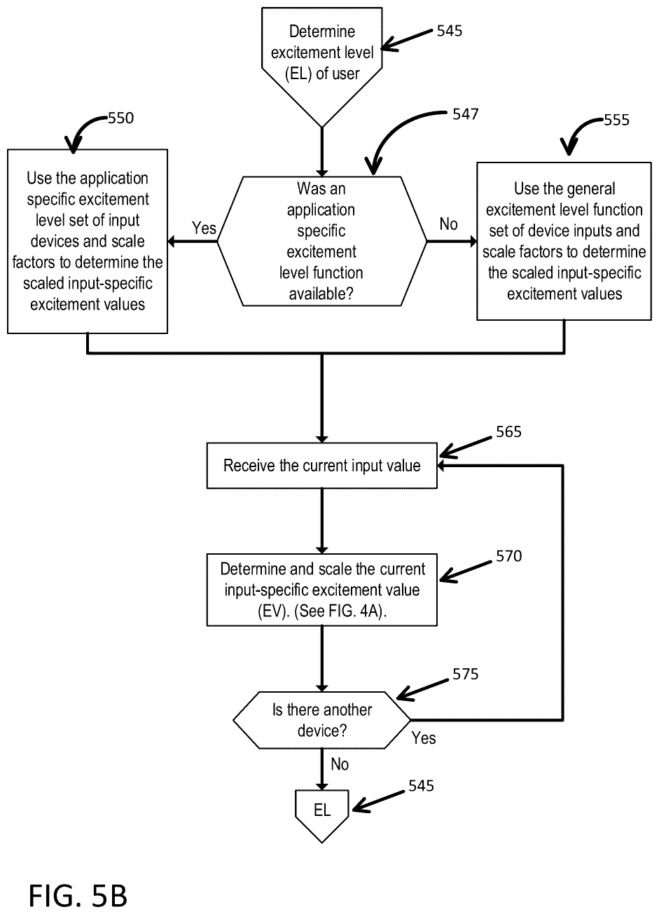

FIGS. 5A and 5B are a flow chart detailing how an excitement level may be determined based on device inputs, and how network resources may be allocated and configured based on the excitement level. The algorithm 500 may be used by a device 200, a gateway 222, a personal computer 114, a smartphone/mobile device 125, or any other desired element described herein. Furthermore, the steps of the algorithm 500 may be divided, and may be performed by different devices as desired.

As detailed in the portion of the flow chart displayed in FIG. 5A, in step 505, network capabilities may be determined. Determining network capabilities in step 505 may comprise determining available bands, bandwidths, communication paths, and/or available channels. In step 505, a device 200 may determine if additional Wi-Fi standards and/or capabilities may be available (e.g., an aggregated media access control (MAC) service data unit (AMSDU)). The device 200 may determine how signal strength may be measured and/or how a flow of transmission control protocol (TCP) packets may be determined. The available network capabilities may determine the available excitement level settings discussed above. For example, table 460 shows a download data rate that varies between 250 kbps and 1 Mbps. This may be suitable if a network's download availability also fits that range. However, if a network's actual download rate is lower (e.g., it peaks at 500 kbps), then the rates in the table 460 may be scaled accordingly. Similarly, if the network supports much higher download rates (e.g., 1 Gbps), then the range in table 460 may be scaled higher, to take advantage of available download bandwidth range.

In step 510, software, firmware, tables, configuration files, etc. may be loaded (downloaded, updated, etc.) or accessed. A device 200 may load or access a physical input and input-specific excitement value determination tables 410 and/or a biometric sensor input and input-specific excitement value determination table 420. The device 200 may load or access an excitement level function table 401. The device 200 may load or access a network parameter configuration table 402. The device 200 may download or access new tables. The device 200 may download or access an updated table based on a table and/or a condition change. The device 200 may download or access updated tables comprising updated input-specific excitement value determination tables 410 and/or updated biometric sensor input and input-specific excitement value determination table 420. The tables may also be scaled as discussed above.

In step 530, an application being used by a user may be determined. An excitement level determination by a device 200 may depend on the application being used, for example, if an application specific excitement level function exists for the application. The user may begin using a different application with a different application specific excitement level table (e.g., a user may switch from Online Racing 440(a) to Kart Battles 440(b)). The device 200 may need to receive a different set of device input values, use a different application specific excitement level function, and/or use a different set of input-specific excitement value scaling factors, for example, if the user switches to using a turn based game application from the user using an online racing game. The network parameter configuration table 402 may change from a turn-based game network configuration table 460 to an online racing network configuration table 470, for example, if the application changes from a turn based game to an online racing game. The device may determine that the application specific excitement level function changes, for example, if the application has changed. The application determined may be the application that is currently open. The application determined may be an application that has the primary input focus of the user. The device 200 may determine the application specific excitement level equation to use and/or the input-specific excitement level values to determine. The device 200 may determine the application specific equation may be the online racing application specific equation 445(a) and/or the input-specific excitement values may be the input-specific excitement values of the online racing game, for example, if the device 200 determines that the application being used is online racing 440(a).

In step 532, the existence of an application specific excitement level function for the application currently being used may be determined. A device 200 may search an excitement level function table 401 for the application determined in step 530. The device 200 may determine the application specific function exists, for example, if the application determined in step 530 exists in the excitement level function table 401. The device 200 may determine the application specific function does not exist, for example, if application determined in step 530 does not exist in the excitement level function table 401. The device 200 may determine an online racing application specific excitement level function 440(a) exists, for example, if the device 200 determined that online racing was the application being used in step 530 and determines the online racing application specific excitement level function 440(a), corresponding to the application determined in step 530, exists in the excitement level function table 401.

If an application specific excitement level function was determined to exist in step 532, in step 535, the application specific excitement level function and/or the application specific input scale factors may be determined for the application determined in step 530. A device 200 may determine an application specific excitement level function to use, for example, based on the application determined in step 530 and the excitement level function table 401. The device 200 may determine the application specific input scale factors set to use for the application specific excitement level function, for example, based on the application determined in step 530, the excitement level function table 401, and/or any additional scale factor determinates. A device 200 may determine that the online racing excitement level function 445(a) may be the application specific excitement level function and the second scale factor set 448(a) may be the application specific input scale factors, for example, if the device 200 determined in step 530 that the application is online racing 440a and that a more heavily weighted throttle would allow the device to more quickly determine a rising excitement value at the beginning of an online race.

If an application specific excitement level function was determined not to exist in step 532, in step 540, a general excitement level function may be determined. A device 200 may determine an excitement level using a general excitement level equation and/or general input-specific excitement values, for example, if an application specific excitement level function is not available.

In step 545, an excitement level of a user of an application may be determined based on the various user inputs discussed above. Details of the steps in determining the excitement level are shown in FIG. 5B.

In step 547, an excitement level function and/or input scaling factors to use in determining excitement level may be determined based on the existence (or lack of existence) of an application specific excitement level function. An excitement level may be determined based on an application specific excitement level function determined in step 535, for example, if the application specific excitement level was determined to exist in step 532. An excitement In level may be determined based on a general excitement level function, for example, if an application specific function was determined not to exist in step 532.

If an application specific function was determined to exist in step 532, then, as described in step 550, a set of inputs and an input-specific excitement value scale set used to determine an excitement level may be the set of inputs and the input-specific excitement value scale set of the application specific excitement level function determined in step 535. An excitement level equation used to determine an excitement level may be the application specific excitement level function determined in step 535. The device 200 may determine that the set of inputs to determine an excitement level may be rotation speed (e.g., using a gyro-meter 208d), taps per second on a touch screen 208e, a first pressure 208j, and/or a second pressure 208j, for example, if the application specific input excitement value scale set scales the input-specific excitement values of angular speed, the number of taps per second, a first pressure and a second pressure. A first input of the set of inputs may be the first current input for step 565.

If an application specific function was determined to not exist in step 532, then, as described in step 555, a set of inputs and an input-specific excitement value scale set used to determine an excitement level may be the set of inputs and the input-specific excitement value scale set of a general excitement level function. An excitement level function may be the general excitement level function. The device 200 may determine the set of input-specific excitement values to determine, based on the scaler set of input-specific excitement values. The device 200 may determine the set of input-specific excitement values to determine based on the physical input and input-specific excitement value determination table 410 and/or the biometric sensor input and excitement value determination table 420 (e.g., as described herein in FIG. 4A). A looping process may then be performed, to process each of the various inputs that are needed. The first element of the set of inputs may be the first current input of step 565.

In step 565, a current input value of the current input may be received. The current input value may be stored. The current input value may be in units of an input described in a physical input and input-specific excitement value table 410 and/or the current input value may be in units of an input described in a biometric sensor input and input-specific excitement value table 420. A current input value may be in radians per second, for example, if the current input is angular speed.

In step 570, a scaled input-specific excitement value for a current input value is determined. A device 200 may determine an input-specific excitement value based on a current input, a current input value, and an input-specific excitement value table (e.g., as described herein in FIG. 4A). The device 200 may determine that an input-specific excitement value of a current input may be equal to 4, for example, if the application is online racing, the device input was angular speed, and the angular speed was 3π/8 radians per second. Certain inputs may be more determinative of user excitement. A user input based on angular rotation may be more indicative of excitement, for example, if an application is online racing and angular rotation is used to steer a vehicle. A user input based on angular rotation may not be indicative of excitement, for example, if an application is a turn based chess game. The device 200 may determine a scaled input-specific excitement value based on multiplying the input-specific excitement value by the corresponding element of the input specific excitement value scale set. The device 200 may determine that the input-specific excitement value may be 2, for example, if the application is online racing, the device input was angular speed (e.g., the scale factor for angular speed is 1/2), and the input-specific excitement value determined was 4. The current input, the current input value, the current input-specific excitement value, and/or the scaled current input-specific excitement value may be stored.

In step 575, a determination may be made as to whether all necessary device inputs have been processed. If there remains an additional device input that needs processing, then the process may return to step 565 to retrieve the next device input. The device 200 may determine the next input-specific excitement value to determine based on determining the next input in the set of inputs. The device 200 may determine the next input-specific excitement value to determine may be a number of taps, for example, if the application specific excitement function is for online racing and the current input is angular speed. The device 200 may determine that there is not a next input. The device 200 may determine that there is not a next input, for example, if the application is online racing 440(a) and the current input is pressure 2.

In step, 580 an excitement level may be determined based on the set of scaled input-specific excitement values and the excitement level function determined in step 550 (e.g., an application specific excitement level equation) or step 555 (e.g., a general excitement level equation). The device 200 may determine the excitement level based on using the set of scaled input-specific excitement values as the elements of the excitement level function. The device may determine an excitement level is 8, for example, if the application is online racing and scaled input-specific excitement values Sₒ₁o1, Sₙn, Sₚ₁p1, and Sₚ₂p2 are as follows: Sₒ₁o1 is 5, Sₙn is 1, Sₚ₁p1 is 1, and Sₚ₂p2 is 1.

In step 585, table 402 may be consulted to determine network configuration properties based on the excitement level and/or the application. A device 200 may determine an upload rate of 1.5 Mbps, a download rate of 2 Mbps, and an application priority of 2, for example, if the application is online racing and the excitement level is 8. A device may determine an upload rate of 250 kbps, a download rate of 250 kbps, and a priority level of 10, for example, if the general network configuration table is used and the excitement level is 1.

In step 590, network resources may be configured based on the determination of network configuration properties of step 585. Configuring network properties may comprise, but is not limited to, increasing or decreasing available bandwidth within a band, steering a connection to a higher or lower frequency band, switching a channel within a band, and/or adjusting the priority level. A device 200 may send a message to a gateway to adjust settings so that actual upload and/or download rates correspond to the determined upload and/or download rates. Adjusting settings may comprise physically switching a channel. A device 200 may send a message to a gateway to adjust a priority of an application and/or a user device at an access point.

A device 200 may continue to monitor excitement levels and determine a change in excitement level while operating. A device 200 may store relevant information concerning a user device and/or an application being used by the user device comprising one or more of a device ID, an application associated with the device (e.g., the application and/or a server associated with the application), the user device excitement level, and/or network configuration properties allocated to the user device comprising a band, channel, bandwidth, and/or a priority level.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

We claim:

1. A method comprising:
receiving information indicating an intensity associated with a user input, wherein the user input is associated with a function of an application being used by a user;
determining, based on the intensity, whether to adjust network resources to implement the function; and
adjusting one or more network configuration parameters to implement the function.

2. The method of claim 1, wherein the information indicates a pressure with which the user input was entered by the user; and wherein the determining is further based on the pressure.

3. The method of claim 1, wherein the information indicates a rate of the user input; and wherein the determining is further based on the rate.

4. The method of claim 1, wherein the information indicates an orientation of a device held by the user; and wherein the determining is further based on the orientation.

5. The method of claim 1, wherein adjusting the one or more network configuration parameters comprises setting, based on the intensity, a data priority associated with the application.

6. The method of claim 1, further comprising receiving second information indicating a second intensity associated with a second user input, wherein the second user input is associated with the function of the application being used by the user; and wherein the determining is further based on the second intensity.

7. The method of claim 1, further comprising:
storing data comprising an intensity level table for the application, wherein the determining is further based on the intensity level table.

8. The method of claim 1, further comprising receiving biometric information of the user, wherein the determining is further based on the biometric information.

9. The method of claim 1, further comprising:
determining, based on an increase in the intensity, that additional network resources are needed to implement the function.

10. The method of claim 1, further comprising:
determining, based on a decrease in the intensity, that fewer network resources are needed to implement the function.

11. A method comprising:
receiving biometric information of a user of an application;
determining, based on the biometric information, that an excitement level of the user warrants an adjustment to network resources for the application; and
adjusting, based on the determining, the network resources.

12. The method of claim 11, wherein the biometric information indicates motion of an eye of the user; and wherein the determining is further based on the eye-motion information.

13. The method of claim 11, wherein the biometric information indicates a heart rate; and wherein the determining is further based on the heart rate.

14. The method of claim 11, wherein the biometric information indicates a change in the excitement level of the user, and wherein the adjusting is based on the change in the excitement level.

15. The method of claim 11, wherein the adjusting is further based on information indicating different network resource levels for different excitement levels.

16. A method comprising:
receiving biometric information of a user at a plurality of times while the user is using an application;
determining, based on the biometric information, changes in an excitement level of the user while the user is using the application; and
dynamically adjusting network resources, during the user's use of the application, based on the changes in the excitement level of the user.

17. The method of claim 16, further comprising:
increasing the network resources based on determining that the excitement level has satisfied a threshold; and
reducing the network resources based on determining that the excitement level has no longer satisfied the threshold.

18. The method of claim 16, further comprising:
increasing a bandwidth for a video game based on determining that user inputs, from a user, are made with more physical pressure than prior user inputs from the user.

19. The method of claim 16, further comprising determining based on an increase in the intensity that additional network resources are needed for the application.

20. The method of claim 16, further comprising determining based on a decrease in the intensity that fewer network resources are needed for the application.
